(19) United States
(12) Patent Application Publication
(10) Pub. No.: US 2026/0171788 A1
(43) Pub. Date: Jun. 18, 2026

(54) AREA-EFFICIENT ELECTROSTATIC DISCHARGE PROTECTION

(71) Applicant: Intel Corporation, Santa Clara, CA (US)

(72) Inventors: Ritesh Agarwal, Munich (DE); Anand Sharma, Karnataka (IN); Harshit Dhakad, Bangalore (IN)

(21) Appl. No.: 18/984,840

(22) Filed: Dec. 17, 2024

(51) Int. Cl. H02H 9/02; H02H 9/00

(52) U.S. Cl. CPC H02H 9/025; H02H 9/005

(57) ABSTRACT

Embodiments herein relate to an electrostatic discharge (ESD) protection circuit which uses stacked transistors such in a discharge path between a power supply rail and the ground rail. The stacked transistors can be in a complementary field-effect transistor (CFET) device and include a p-type transistor and an n-type transistor stacked one atop the other. The discharge path can include a set of CFET devices in parallel. The set of CFET devices can be formed on a common substrate and include shared channel ribbons.

### BACKGROUND

Electrostatic discharge (ESD) can occur in semiconductor devices when a sudden flow of electricity, caused by a difference in electrical potential, is triggered. For example, the device can accumulate static charges and discharge them to other components. The discharge is typically through conductive pins or terminals. It represents one of the primary ESD failure mechanisms in semiconductor devices, especially during manufacturing, testing, or handling.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A depicts a cross-sectional view in a y-z plane of an example complementary field-effect transistor (CFET) device 100, including an n-channel Metal-Oxide-Semiconductor Field-Effect Transistor (MOSFET) TN below a p-channel MOSFET TP, in accordance with various embodiments.

FIG. 1B depicts a cross-sectional view in an x-z plane of the CFET device 100 of FIG. 1A along the line 101, in accordance with various embodiments.

FIG. 2A depicts a cross-sectional view in an x-z plane of a set of CFET devices 200 including the CFET device 100 of FIG. 1A and a CFET device 210, where the channel ribbons 110, 111, 120 and 121 are shared among the set of CFET devices, in accordance with various embodiments.

FIG. 2B depicts a cross-sectional view in an x-z plane of a set of CFET devices 200 including the CFET device 100 of FIG. 1A and an adjacent CFET device 210a, where the adjacent CFET devices have respective source/drain regions in shared silicon regions 250 and 255, in accordance with various embodiments.

FIG. 2C depicts different possible configurations of a resistor divider in CFET technology, in accordance with various embodiments.

FIG. 3 depicts a cross-sectional view in an x-z plane of a CFET device 300 having four transistors TN1, TN2, TP1 and TP2 stacked vertically one atop the other, in accordance with various embodiments.

FIG. 4 depicts an example comparative ESD protection circuit 400 which includes a discharge path 405 via nMOS transistors 420 and 430 in a two-dimensional (2D) configuration.

FIG. 5 depicts an example comparative ESD protection circuit 500 which includes a discharge path 505 via pMOS transistors 520 and 530 in a 2D configuration.

FIG. 6 depicts an example comparative ESD protection circuit 600 which includes first and second CFET devices 620 and 630, respectively, where a discharge path 605 is via nMOS transistors 622 and 632, while the pMOS transistors 621 and 631 are unused.

FIG. 7 depicts an example comparative ESD protection circuit 700 which includes the first and second CFET devices 620 and 630, respectively, of FIG. 6, where a discharge path 705 is via the pMOS transistors 621 and 631, while the nMOS transistors 622 and 632 are unused.

FIG. 8 depicts a comparative example ESD protection circuit 800, where a discharge path 815 is via nMOS transistors 810 and 811.

FIG. 9 depicts a comparative example ESD protection circuit 900, where a discharge path 905 is via pMOS transistors 910 and 911.

FIG. 10 depicts an example ESD protection circuit 1000 which includes the trigger circuit 610 and the CFET device 620 of FIG. 6, where a discharge path 1005 is via the pMOS transistor 621 under the control of a secondary trigger circuit 1015, and the nMOS transistor 622 under the control of the trigger circuit 610, in accordance with various embodiments.

FIG. 11 depicts an example ESD protection circuit 1100 which includes the trigger circuit 710 and the CFET device 620 of FIG. 6, where a discharge path 1105 is via the pMOS transistor 621 under the control of the trigger circuit 710, and the nMOS transistor 622 under the control of a secondary trigger circuit 1115, in accordance with various embodiments.

FIG. 12 depicts an example area-efficient ESD protection circuit 1200 which includes a discharge path 1205 through a CFET device 1220, including a pMOSFET 1221 above an nMOSFET 1220, in accordance with various embodiments.

FIG. 13 depicts an example area-efficient ESD protection circuit 1300 which includes a discharge path 1305 through a CFET device 1320, including an nMOSFET 1321 above a pMOSFET 1320, in accordance with various embodiments.

FIG. 14 depicts an example implementation of the CFET device 1220 of FIG. 12, including multiple CFET devices 1410 and 1420 in parallel, in accordance with various embodiments.

FIG. 15 depicts an ESD protection circuit 1500 which is an example implementation of the ESD protection circuit 1200 of FIG. 12, in accordance with various embodiments.

FIG. 16 depicts an example implementation of the voltage divider 1510 of FIG. 15, in accordance with various embodiments.

FIG. 17 depicts an ESD protection circuit 1700 which is another example implementation of the ESD protection circuit 1200 of FIG. 12, in accordance with various embodiments.

FIG. 18 depicts an ESD protection circuit 1800 which includes a series of diodes 1810 to reduce a voltage across the components of the circuit, in accordance with various embodiments.

FIG. 19 depicts an ESD protection circuit 1900 similar to the circuit 1200 of FIG. 12 but with a CFET device 1950 having four stacked transistors, consistent with FIG. 3, in accordance with various embodiments.

FIG. 20 illustrates an example of components that may be present in a computing system 2050 for implementing the techniques (e.g., operations, processes, methods, and methodologies) described herein.

### DETAILED DESCRIPTION

As mentioned at the outset, an ESD event can result in the failure of a circuit if the event is not properly handled.

As semiconductor technology advances, the scaling down of device geometries has resulted in a transition from 2D planar transistor structures to 3D configurations. This evolution is exemplified, e.g., by the introduction of Complementary Field Effect Transistors (CFETs) as a next-generation transistor technology, where n-type and p-type transistors are vertically integrated, one atop the other.

A CFET device is a type of semiconductor device that stacks n-type and p-type transistors on top of each other in a single, integrated process. Two or more transistors can be stacked on top of each other in a vertical configuration. CFET devices are also referred to as gate-all-around FET devices, and include variants such as Ribbon field-effect transistor (FET), nanowire, nanosheet, and nanoribbon. A GAA transistor has a gate surrounding the channel from all sides. A RibbonFET can include a channel formed by a stack of very thin, ribbon shaped semiconductor sheets. A nanowire is a type of FET where the conducting channel is made from a very thin, cylindrical nanowire. A nanosheet is a type of FET where the channel is made from a single ribbon-like structure at the nanoscale, often made from materials such as graphene.

While this 3D stacking of transistors offers significant benefits in terms of area reduction and performance gains for various integrated circuit (IC) components, including memory elements, Electrostatic Discharge (ESD) clamps, and input/output (IO) interfaces, it also presents new challenges in the design of Electrostatic Discharge (ESD) protection circuits, also referred to as ESD clamps since they clamp the supply voltage at a level which does not causes damage during an ESD event. ESD clamps are used for safeguarding IC power supply nodes against ESD events. These clamps are designed according to the voltage levels they protect, with a distinction between core and IO voltages. The IO voltage is higher, reaching up to, e.g., 1.8 V, while the core voltage might be about half that, e.g., 0.9 V, for example.

An ESD clamp can include a trigger circuit and a primary discharge component, sometimes referred to as a BigMOS, which is large transistor, often ranging to thousands of micrometers in width, that directs the ESD energy between the power rails. However, the BigMOS is a dominant factor in the clamp's layout, consuming a significant amount of area, typically between 50-70% of the total ESD clamp footprint.

Generally, a core voltage can refer to the primary voltage supplied directly to the central processing unit (CPU) core of a computing device, while an IO voltage is the voltage used for the chip's external communication interfaces like memory controllers and peripheral connections.

For core voltage ESD clamps, a single large nMOSFET (n-type MOSFET) or pMOSFET (p-type MOSFET) transistor can act as the BigMOS. Since the CFET technologies offer core voltage devices for higher IO voltage ESD clamps, the design can involve stacking of core devices in homogeneous configurations (e.g., nMOSFET-nMOSFET or pMOSFET-pMOSFET stacks). However, this stacking approach leads to increased layout area and introduces potential reliability issues due to the complexity of the stacked structures and the vulnerability of their interconnections.

Moreover, an ESD clamp design for IO voltage applications within CFET technology may not fully exploit the intrinsic benefits of the complementary transistor configuration. For example, if an nMOSFET is used as a clamping device, the complementary pMOSFET remains idle and unused, leading to an underutilization of the technology's advanced capabilities.

The solutions provided herein address the above and other disadvantages. In one aspect, the solutions provide an ESD clamp architecture which integrates supplementary circuit elements. For example, an ESD protection circuit can include one or more CFET devices where an ESD discharge path is provided using each transistor in the CFET device. The discharge path can extend between a power supply rail and a ground rail. In an example implementation, the ESD protection circuit includes a trigger circuit, and one or more CFET devices of the discharge path. The trigger circuit detects an ESD event based on a voltage on a power supply rail and concurrently turns on the transistors in the one or more CFET devices to open the discharge path. The trigger circuit may receive a voltage from a voltage divider.

In one approach, the discharge path includes multiple CFET devices arranged in parallel to reduce the current load on each CFET device. The discharge path can include, e.g., an nMOSFET above a pMOSFET, or a pMOSFET above an nMOSFET in each CFET device.

In another option, a CFET device includes more than two transistors stacked vertically. An example implementation includes two pMOS transistors and two nMOS transistors.

In another example implementation, a series of diodes is placed between the power supply rail and an intermediate power supply rail to reduce the voltage at the intermediate power supply rail and thereby reduce the load on the transistors.

CFET devices can be used in the discharge path as well as in other areas of the ESD protection circuit.

The solutions provide a number of advantages, including a 50% reduction in the area of a ESD compared to multiple series-connected BigFETs in a 2D configuration. Additional area savings can be realized through implementing a voltage divider using pMOSFET-nMOSFET or nMOSFET-pMOSFET configurations, and integrating pMOS and nMOS transistors to form compact resistors and capacitors. The CFET structure allows for improved current handling by strengthening the middle node, enhancing the overall robustness of the ESD clamp. Moreover, the solutions exhibit decreased sensitivity to process variations, improving the reliability and yield of the ESD clamps across different manufacturing conditions. The solutions thus provide more efficient use of chip area, improved performance, and greater ESD robustness.

These and other features will be further apparent in view of the following discussion.

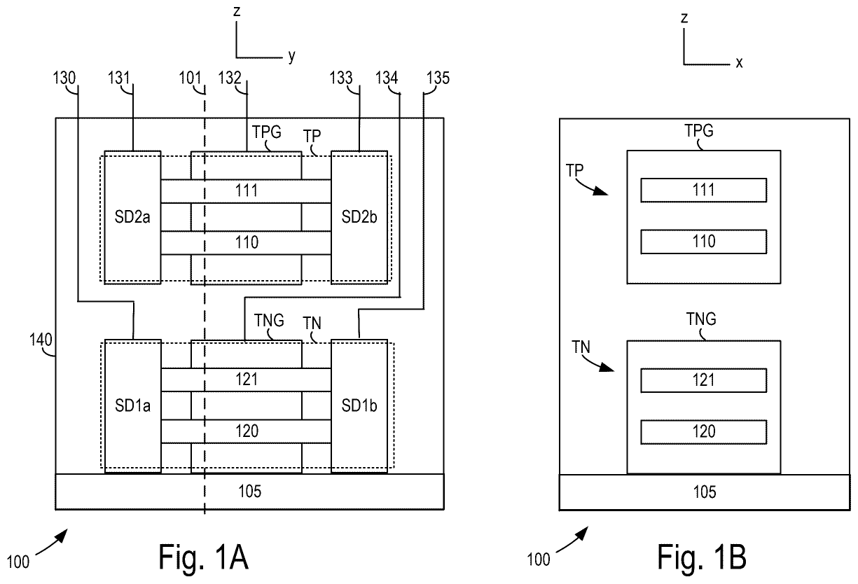

FIG. 1A depicts a cross-sectional view in a y-z plane of an example complementary field-effect transistor (CFET) device 100, including an n-channel MOSFET (nMOS) TN below a p-channel MOSFET (pMOSFET) TP, in accordance with various embodiments. Alternatively, the positions of the transistors can be reversed, with TN atop TP. One transistor being atop another transistor means, e.g., that the another transistor is directly below the one transistor and within a footprint of the one transistor.

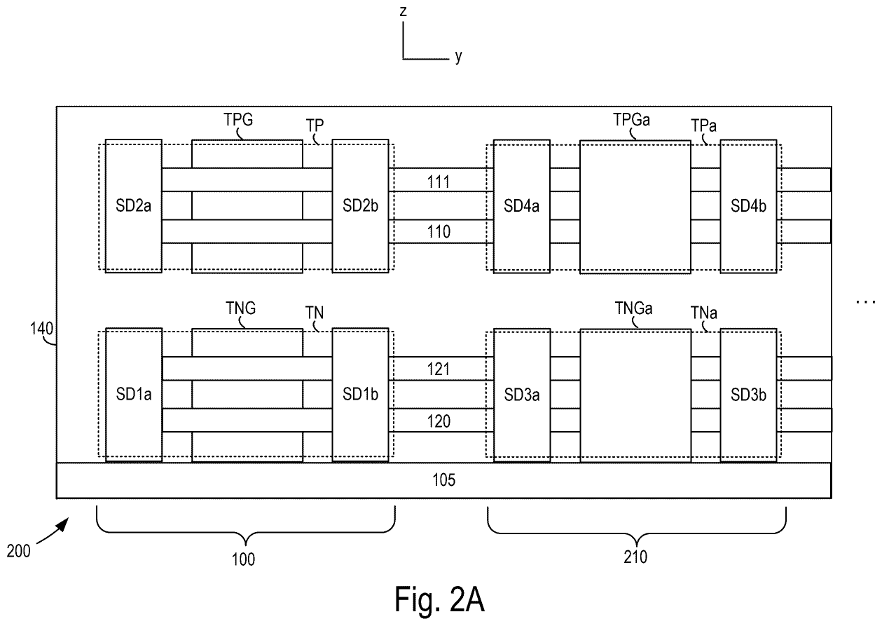

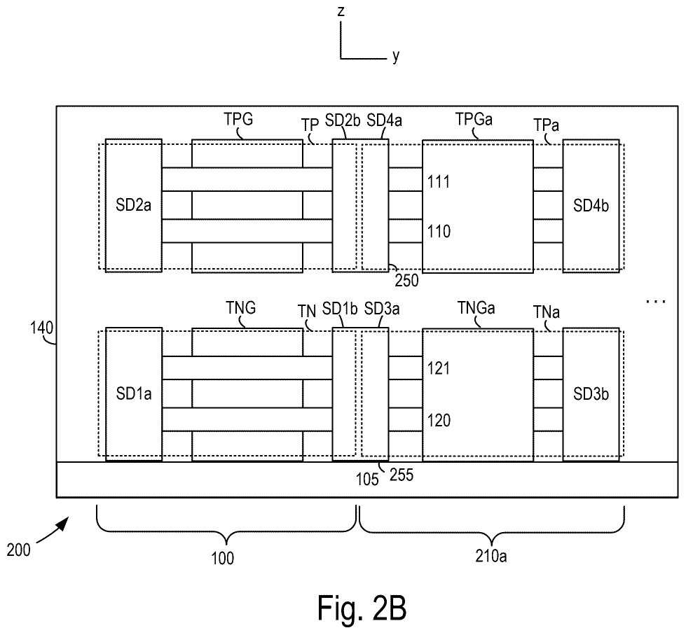

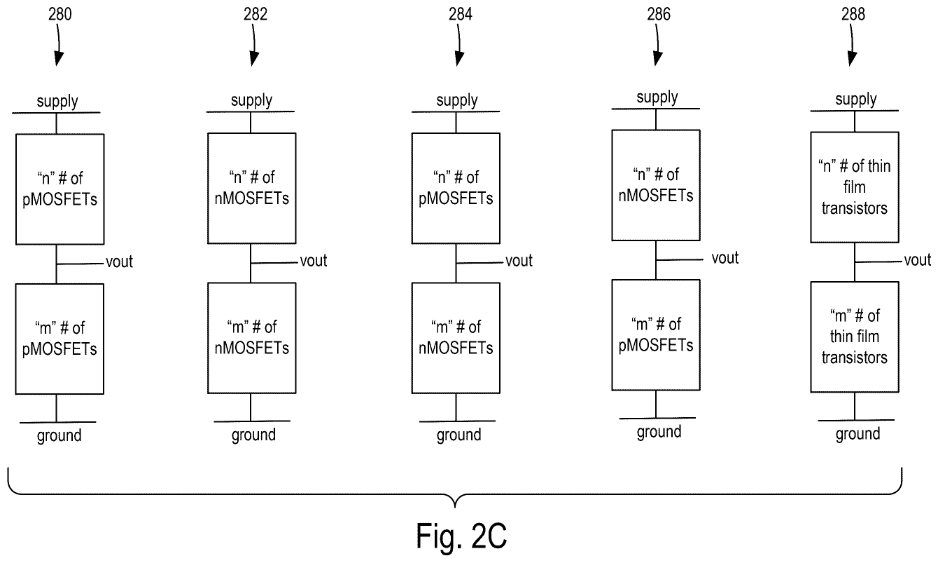

The CFET device is formed on a substrate 105. The pMOSFET TP includes source/drain nodes SD2a and SD2b, a gate TPG and one or more ribbons 110 and 111 of undoped or light doped silicon which extend between the source/drain nodes. The ribbons are shown as being contained within one CFET device in this example but, in practice, may extend to encompass many CFET devices (see FIG. 2). The source, drain and gate are terminals of a transistor. The gate TPG extends all around the ribbons, which can form respective conductive channels between the source and the drain when the control gate voltage is sufficiently low. The nMOSFET TN includes source/drain nodes SD1a and SD1b, a gate TNG and one or more ribbons 120 and 121 of undoped or light doped silicon which extend between the source/drain nodes. The gate TNG extends all around the ribbons, which can form respective conductive channels between the source and the drain when the control gate voltage is sufficiently high.

The gate material can be, e.g., any known metal gate material, such as TiN, TiAl, or TiC. The ribbons can be, e.g., nanosheet channels which are made up of thin, alternating layers of silicon and silicon germanium. The source/drain terminals can be doped silicon including epitaxial silicon.

The CFET device includes conductive paths, e.g., interconnects, which extend upward from the terminals to the top metal layer for routing. In one approach, the vertical portions of the paths (z-direction) are vias such as metal plated through-vias, for example, or other conductive material. The horizontal (y-direction) portions of the paths can be a conductive silicon, for instance such as polysilicon. The conductive paths can be coupled to contacts of the source/drain terminals. For example, the conductive paths 130, 131, 133 and 135 are coupled to SD1a, SD2a, SD2b and SD1b, respectively. The conductive paths 132 and 134 can be coupled directly to TNG and TPG, respectively, in one approach. The transistors TN and TP can be embedded in a dielectric material 140.

In another option, the interconnects include bottom metal layers. Interconnects contained within the CFET device are also possible. The interconnects allow connections to other CFET devices/transistors and/or between terminals within the same CFET device/transistor.

FIG. 1B depicts a cross-sectional view in an x-z plane of the CFET device 100 of FIG. 1A along the line 101, in accordance with various embodiments. This view shows the ribbons 110 and 111 of TP and the ribbons 120 and 121 of TN.

FIG. 2A depicts a cross-sectional view in an x-z plane of a set of CFET devices 200 including the CFET device 100 of FIG. 1A and a CFET device 210, where the channel ribbons 110, 111, 120 and 121 are shared among the set of CFET devices, in accordance with various embodiments. The CFET device 210 includes a pMOSFET TPa above an nMOSFET TNa. TPa includes source/drain regions SD4a and SD4b and a gate TPGa. TNa includes source/drain regions SD3a and SD3b and a gate TNGa. The set can include more than two CFET devices on a common substrate. In an example implementation, the CFET devices are arranged in parallel in an ESD discharge path to reduce the current load on each device. For example, see FIG. 14.

Note that CFET is one example of a device having vertically stacked transistors, as other implementations are possible.

In another example implementation, the channel ribbons are not shared among CFET devices and instead the portions of the ribbons between the CFETs 100 and 210 are removed.

FIG. 2B depicts a cross-sectional view in an x-z plane of a set of CFET devices 200 including the CFET device 100 of FIG. 1A and an adjacent CFET device 210a, where the adjacent CFET devices have respective source/drain regions in shared silicon regions 250 and 255, in accordance with various embodiments. For example, the silicon region 250 is used to provide SD2b for the transistor TP and SD4a for the transistor TPa. Also, the silicon region 255 is used to provide SD1b for the transistor TN and SD3a for the transistor TNa. This approach is more compact.

FIG. 2C depicts different possible configurations of a resistor divider implementation in CFET, in accordance with various embodiments. In a configuration 280, “n” number (#) of stacked pMOSFETs are above “m” number of stacked pMOSFETS. In a configuration 282, “n” number of stacked nMOSFETs are above “m” number of stacked nMOSFETS. In a configuration 284, “n” number of stacked pMOSFETs are above “m” number of stacked nMOSFETS. In a configuration 286, “n” number of stacked nMOSFETs are above “m” number of stacked pMOSFETS. In a configuration 288, “n” number of thin-film transistors are above “m” number of thin-film transistors. “n” and “m” are any integer greater than or equal to two.

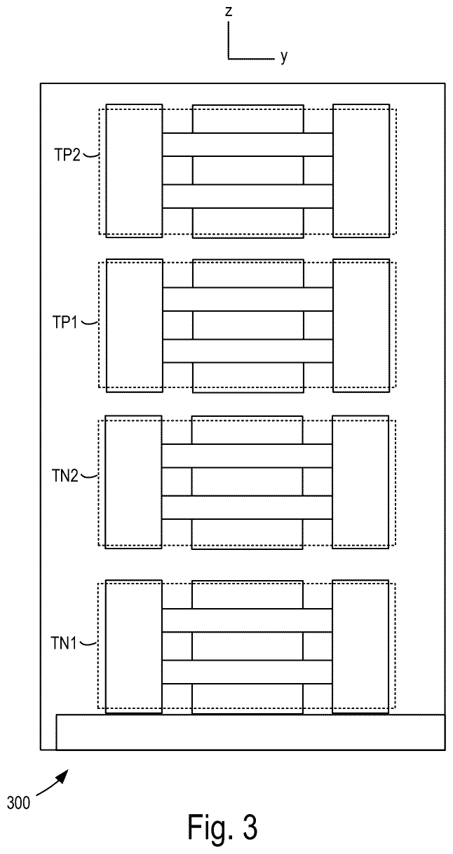

FIG. 3 depicts a cross-sectional view in an x-z plane of a CFET device 300 having four transistors TN1, TN2, TP1 and TP2 stacked vertically one atop the other, in accordance with various embodiments. This approach provides even better area efficiency, although with some increased complexity. In this approach, the nMOS transistors are adjacent to one another and the pMOSFET transistors are adjacent to one another. In another possible approach, the top and bottom transistors are of one polarity and the middle two transistors are of the opposite polarity. In another possible approach, the polarities alternate for each consecutive transistor.

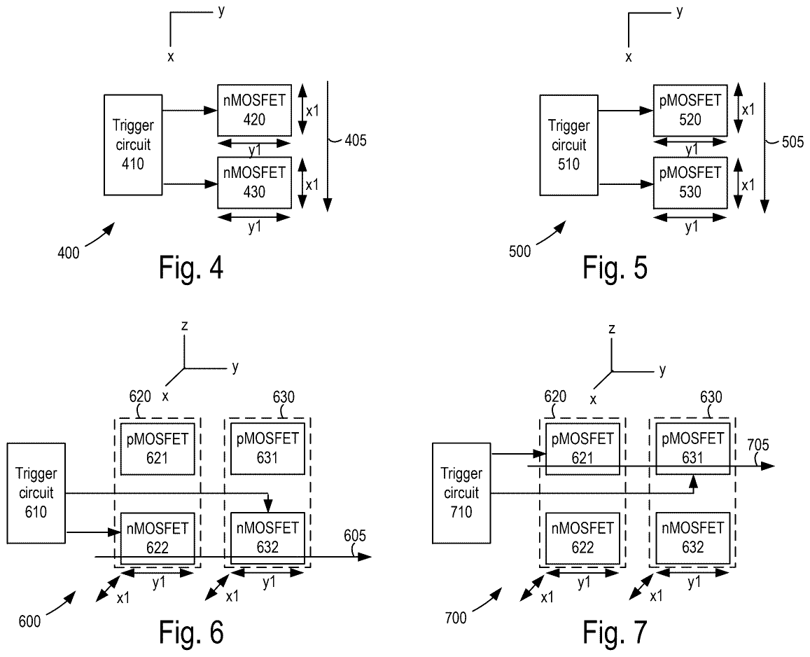

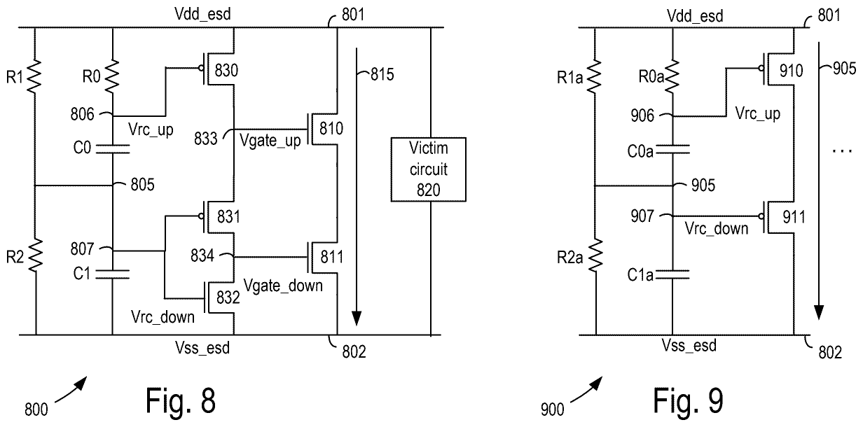

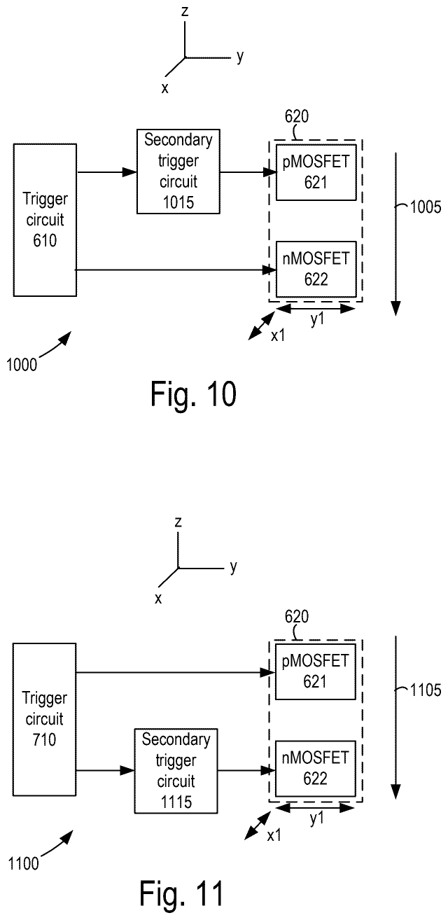

FIG. 4 depicts an example comparative ESD protection circuit 400 which includes a discharge path 405 via nMOS transistors 420 and 430 in a two-dimensional (2D) configuration. In the 2D configuration, the transistors are arranged side-by-side in an x-y plane, which is a horizontal plane of the surface of the substrate. Each transistor has an area of x1 by y1 in the x-y plane, for a total area of 2*x1 *y1 for the two transistors. A trigger circuit 410 is used to control each transistor with a respective control signal applied to the control gate. This approach is not area-efficient since each transistor in the discharge path consumes separate space on the plane of the substrate.

FIG. 5 depicts an example comparative ESD protection circuit 500 which includes a discharge path 505 via pMOS transistors 520 and 530 in a 2D configuration. As before, each transistor has an area of x1 by y1, for a total area of 2*x1*y1 for the two transistors. A trigger circuit 510 is used to control each transistor with a respective control signal applied to the control gate. This approach is also not area-efficient.

FIG. 6 depicts an example comparative ESD protection circuit 600 which includes first and second CFET devices 620 and 630, respectively, where a discharge path 605 is via nMOS transistors 622 and 632, while the pMOS transistors 621 and 631 are unused. The first CFET device 620 includes a pMOSFET 621 above an nMOSFET 622, and the second CFET device 630 includes a pMOSFET 631 above an nMOSFET 632. The nMOSFETs each have dimensions of x1 by y1 in the x-y plane for a total area of 2*x1*y1 in the x-y plane for the two transistors and the respective CFET devices. The planar area of the CFET devices in FIG. 6 is therefore similar to that of the planar transistors in FIG. 4. As a simplification, this example assumes a CFET device and its transistors have a same planar area as a planar transistor.

A trigger circuit 610 is used to apply a respective control signal to the control gates of the nMOSFETs.

This approach is also not area-efficient.

FIG. 7 depicts an example comparative ESD protection circuit 700 which includes the first and second CFET devices 620 and 630, respectively, of FIG. 6, where a discharge path 705 is via the pMOS transistors 621 and 631, while the nMOS transistors 622 and 632 are unused. The planar area of the CFET devices in FIG. 7 is similar to that of the planar transistors in FIG. 5.

A trigger circuit 710 is used to apply a respective control signal to the control gates of the pMOSFETs.

This approach is also not area-efficient.

FIG. 8 depicts a comparative example ESD protection circuit 800, where a discharge path 815 is via nMOS transistors 810 and 811. FIGS. 8 and 9 use same-polarity transistors in the discharge path, either in a 2D or 3D configuration, which is not area-efficient, as discussed. These circuits are provided as a comparative example. A power supply rail 801 has a voltage Vdd_esd during an ESD event. At other times, the power supply rail 801 or node may have a voltage of Vdd<Vdd_esd. A ground rail 802 has a voltage Vss_esd during an ESD event. In some cases, Vss_esd=Vss=0 V. The discharge path 815 represents a conductive path for current to discharge from the power supply rail 801 to the ground rail 802, to protect a potential victim circuit 820 from ESD damage. The path shunts current from the victim circuit. The victim circuit is omitted from FIGS. 9-13, 15 and 17-19 for simplicity, but is denoted by three dots ( . . . ). When there is no ESD event detected, the discharge path is turned off and the victim circuit receives the full current on the power supply rail 801.

In the figures, R denotes a resistor and C denotes a capacitor. The ESD protection circuit 800 includes a voltage divider formed by resistors R1 and R2 in series. A node 805 between these resistors has a reduced voltage of Vdd_esd*R2/(R1+R2). The voltage divider allows use of transistors with a reduced voltage rating. A series path including R0, C0 and C1 acts as a detection circuit. An additional series path including pMOSFETs 830 and 831 and an nMOSFET 832 acts as a control circuit for nMOSFETs 810 and 811 in the discharge path. In particular, a control gate of the pMOSFET 830 is coupled to a node 806 which is between R0 and C0, to receive a voltage Vrc_up. Control gates of the pMOSFET 831 and the nMOSFET 832 are coupled to one another and to a node 807 which is between C0 and C1, to receive a voltage Vrc_down. The resistors and capacitors may form a low pass filter.

When Vdd_esd spikes to a sufficiently high level, the pMOSFET 830 turns on (becomes conductive) because its gate-to-source voltage becomes more negative than its threshold voltage (Vth). The node 833 (Vgate_up) is pulled high, thereby turning on the nMOSFET 810. Similarly, the pMOSFET 831 turns on so that the node 834 (Vgate_down) is pulled high, thereby turning on the nMOSFET 811. The discharge path 815 then becomes conductive.

FIG. 9 depicts a comparative example ESD protection circuit 900, where a discharge path 905 is via pMOS transistors 910 and 911. A voltage divider includes R1a and R2a. A detection/control circuit includes in a series path, R0, C0a and C1a. The discharge path includes pMOSFETs 910 and 911, rather than the nMOSFETs of FIG. 8.

When Vdd_esd spikes to a sufficiently high level, the pMOSFETs 910 and 911 turn on. The pMOSFET 910 receives a control gate voltage Vrc_up from a node 906 which is between R0a and C0a, and the pMOSFET 911 receives a control gate voltage Vrc_down from a node 907 which is between C0a and C1a.

FIG. 10 depicts an example ESD protection circuit 1000 which includes the trigger circuit 610 and the CFET device 620 of FIG. 6, where a discharge path 1005 is via the pMOS transistor 621 under the control of a secondary trigger circuit 1015, and the nMOS transistor 622 under the control of the trigger circuit 610, in accordance with various embodiments. The secondary trigger circuit 1015 in turn is responsive to the trigger circuit 610, a primary trigger circuit. The circuit represents a conceptual modification of the circuit of FIG. 6, which provides a trigger for an nMOS transistor, to also provide a trigger for a pMOSFET.

This approach is area-efficient since each transistor in the discharge path does not consume a separate area on the plane of the substrate. Instead, only the area for one transistor/CFET device is consumed.

FIG. 11 depicts an example ESD protection circuit 1100 which includes the trigger circuit 710 and the CFET device 620 of FIG. 6, where a discharge path 1105 is via the pMOS transistor 621 under the control of the trigger circuit 710, and the nMOS transistor 622 under the control of a secondary trigger circuit 1115, in accordance with various embodiments. The secondary trigger circuit 1115 in turn is responsive to the trigger circuit 710, a primary trigger circuit. The circuit represents a conceptual modification of the circuit of FIG. 7, which provides a trigger for a pMOS transistor, to also provide a trigger for an nMOSFET. This approach is also area-efficient.

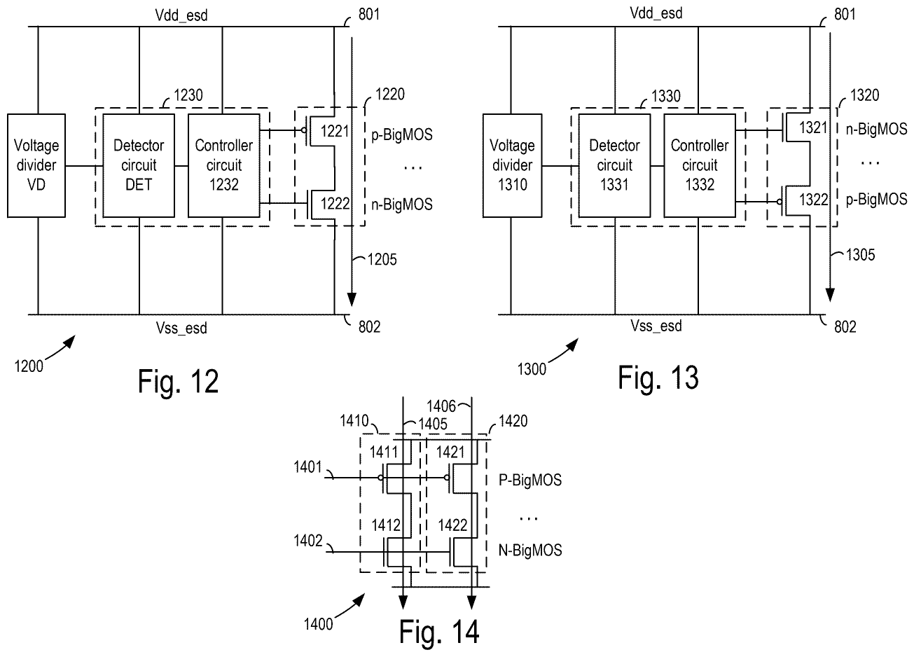

FIG. 12 depicts an example area-efficient ESD protection circuit 1200 which includes a discharge path 1205 through a CFET device 1220, including a pMOSFET 1221 above an nMOSFET 1220, in accordance with various embodiments. The circuit includes a voltage divider VD, a trigger circuit 1230 comprising a detector circuit DET and a controller circuit 1232, and a CFET device 1220 in the discharge path including a pMOSFET 1221 and an nMOSFET 1222. The transistors are BigMOSes denoted by p-BigMOS and n-BigMOS. The detector circuit receives a voltage from the voltage divider and detects when an ESD event occurs, and the controller circuit is responsive to the detector circuit to control the transistors in the discharge path.

The voltage divider, detector circuit and controller circuit are an example of one or more circuits which are configured to control the transistors in the discharge path.

FIG. 13 depicts an example area-efficient ESD protection circuit 1300 which includes a discharge path 1305 through a CFET device 1320, including an nMOSFET 1321 above a pMOSFET 1320, in accordance with various embodiments. The circuit 1300 is similar to the circuit 1200 except the nMOSFET 1321 is above the pMOSFET 1322 in the CFET device 1320. The circuit 1300 includes a voltage divider 1310, a trigger circuit 1330 comprising a detector circuit 1331 and a controller circuit 1332, and a CFET device 1320 in the discharge path including an nMOSFET 1321 and a pMOSFET 1322.

FIG. 14 depicts an example implementation of the CFET device 1220 of FIG. 12, including multiple CFET devices 1410 and 1420 in parallel, in accordance with various embodiments. The p-BigMOS can be provided by the individual pMOSFETs of multiple CFET devices in parallel, where the control gates are commonly controlled. Similarly, the n-BigMOS can be provided by the individual nMOSFETs of the multiple CFET devices in parallel. For example, the CFET devices 1410, 1420, ... are connected in parallel, the control gates of the pMOSFETs 1411, 1421, . . . are coupled to a common path 1401 and the control gates of the nMOSFETs 1412, 1422, . . . are coupled to a common path 1402. With this configuration, a separate discharge path can be provided through each CFET device. For example, CFET devices 1410 and 1420 have discharge paths 1405 and 1406, respectively.

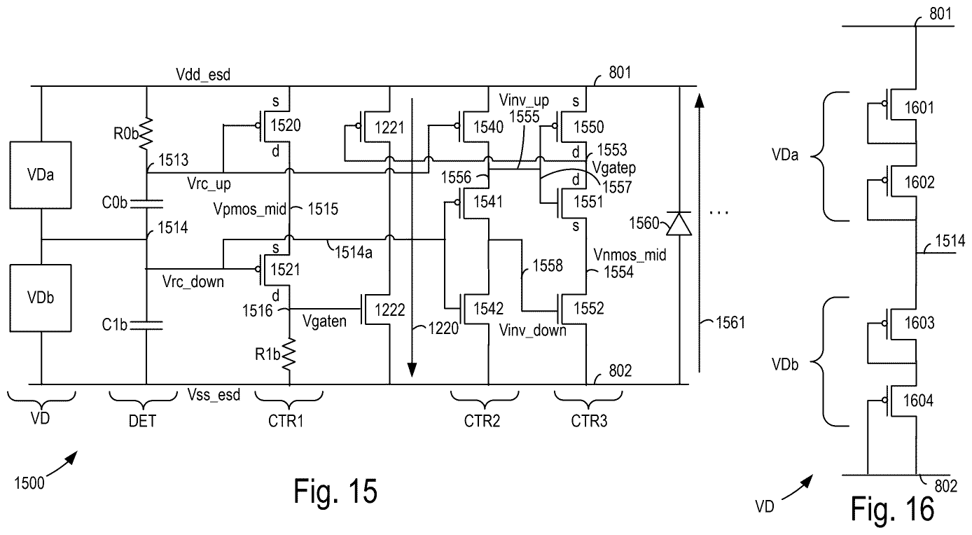

FIG. 15 depicts an ESD protection circuit 1500 which is an example implementation of the ESD protection circuit 1200 of FIG. 12, in accordance with various embodiments. The discharge path 1220 includes the pMOSFET 1221 and the nMOSFET 1222. The voltage divider VD includes resistive components VDa and VDb. The detector circuit DET includes in a series path R0b, C0b and C1b. The controller circuit 1232 includes series paths CTR1, CTR2 and CTR3, and generates control gate voltages for the pMOSFET 1221 and nMOSFET 1222. In particular, the series path CTR3 generates Vgatep at a node 1553 for the control gate of pMOSFET 1221, and the series path CTR1 generates Vgaten at a node 1516 for the nMOSFET 1222. The series path CTR1 includes pMOSFETs 1520 and 1521 and a resistor R1b. The series path CTR2 includes pMOSFETs 1540 and 1541 and an nMOSFET 1542. The series path CTR3 includes a pMOSFET 1550 and nMOSFETs 1551 and 1552.

An inverter is formed by the transistors 1550 and 1551, which are connected in series with their control gates connected to one another. An inverter is also formed by the transistors 1541 and 1542, which are connected in series with their control gates connected to one another.

An example implementation of the voltage divider is provided in FIG. 16.

The trigger circuit 1230 is divided into a detector circuit DET and a controller circuit 1232, as discussed. The detector circuit uses R0b, C0b, and C1b to form a low pass filter that detects ESD events, distinguishing them from normal power-up sequences. The capacitors and resistors in this circuit can also be implemented using pMOSFETs and nMOSFETs, contributing to the compactness of the design.

The controller circuit 1232 controls the gate voltages of the BigMOS devices 1221 and 1222 using transistors 1520, 1521, 1540-1542, 1550-1552, and the resistor R1b.

The discharge devices 1221 and 1222 are responsible for carrying ESD current from the power supply rail 801 to the ground rail 802 during an ESD event.

During a positive ESD event, the circuit 1500 operates as follows. The detector circuit DET identifies the ESD event, preventing capacitors C0b and C1b from charging immediately and keeping node 1513 (Vrc_up) and 1514 (Vrc_down) near 0 V. The pMOSFETs 1520 and 1521 are turned on, thus turning on nMOSFET 1222 by elevating Vpmos_mid at node 1515 and Vgaten at node 1516 to the supply voltage, Vdd_esd. Node 1514 is an output of the VD.

Concurrently, Vrc_up at node 1513 and Vrc_down at nodes 1514 and 1514a turn on pMOSFETs 1540 and 1541, which thus turn on nMOSFETs 1551 and 1552, bringing Vgatep at node 1553 and Vnmos_mid at node 1554 to 0 V and turning on pMOSFET 1221.

Both BigMOS devices 1221 and 1222 are thus turned on to shunt the ESD current from the supply to ground.

During a negative ESD event, the ESD protection circuit 1500 can use a path with a diode 1560 to conduct current in a current path 1561 from the ground rail 802 to the power supply rail 801. A path with a diode can be added in the other example ESD protection circuits similarly.

During normal functionality, with no ESD event, the circuit 1500 operates as follows. The voltage divider VD sets Vrc_down to Vdd/2, for instance, and Vrc_up to Vdd, keeping the pMOSFETs 1520 and 1521 off, while resistor R1b maintains Vgaten at 0 V, keeping the nMOSFET 1222 off.

Vrc_up is at the supply voltage to keep pMOSFET 1540 off, turning the nMOSFET 1542 on, which sets Vinv_down at node 1558 to 0 V and Vinv_up at a node 1555 to Vdd/2. The node 1555 couples a node 1556, which is between pMOSFETs 1540 and 1541, to a node 1557, which is coupled to control gates of the transistors 1550 and 1551.

The pMOSFET 1550 is turned on by the voltages Vinv_up and Vinv_down, keeping Vgatep at Vdd and the pMOSFET 1221 off.

Both transistors 1221 and 1222 in the discharge path remain off during normal operations, minimizing leakage current.

Example voltages in the ESD protection circuit during the normal operations are as follows: Vdd=1.5 V, Vrc_up=1.5 V, Vrc_down=0.75 V, Vpmos_mid=0.75 V, Vnmos_mid=0.75 V, Vgatep=1.5 V, Vgaten=0 V, Vinv_up=0.75 V and Vinv_down=0 V.

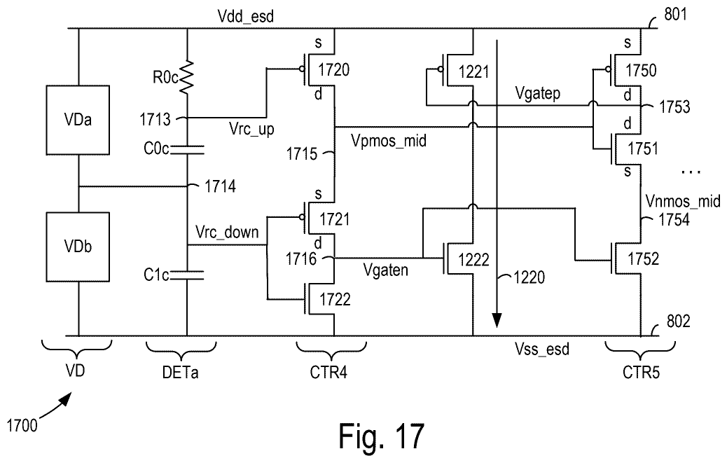

The source(s) and drain (d) of some of the transistors is depicted in FIGS. 15 and 17 for reference, assuming the voltage on the rail 801 exceeds the voltage on the rail 802. The gate of each transistor is depicted by the vertical line of the transistor symbol. A pMOSFET has a circle on the gate while an MOSFET does not.

A number of design considerations can be provided. For example, the ESD protection circuit 1500 may be designed to ensure that no transistor exceeds its safe maximum operating voltage when operating at voltages higher than the core voltage.

Simulation results in GAA technology validate the functionality of the proposed ESD clamp, demonstrating its ability to effectively shunt ESD energy while maintaining a compact footprint and adhering to safe operating conditions for the transistors.

The design's efficiency in terms of area and reliability is expected to be superior to traditional ESD clamps, as evidenced by the reduced number of stacked devices and the use of 3D technologies such as CFET.

The ESD clamp design reduces the silicon area required for ESD protection and enhances the reliability of the circuit.

FIG. 16 depicts an example implementation of the voltage divider 1510 of FIG. 15, in accordance with various embodiments. The voltage divider can include resistors and/or transistors which act as resistive elements to divide the supply voltage to a manageable level for the transistors of the ESD protection circuit. In this example, the resistive component VDa includes pMOS transistors 1601 and 1602 between the power supply rail 801 and the node 1514, and the resistive component VDb includes pMOS transistors 1603 and 1604 between the supply rail ground and the node 1514. Generally, the voltage divider can be implemented using a series of pMOSFETs or a combination of pMOSFET-nMOSFET, nMOSFET chains, polysilicon resistors, metal, thin-film resistors and nanoWattt (nW) resistors, offering flexibility in design as shown in FIG. 2C.

The VR can have more than for transistors to reduce leakage.

FIG. 17 depicts an ESD protection circuit 1700 which is another example implementation of the ESD protection circuit 1200 of FIG. 12, in accordance with various embodiments. Compared to FIG. 15, this implementation of an ESD protection circuit offers a more compact design while still delivering the intended functionality.

The discharge path 1220 includes the pMOSFET 1221 and the nMOSFET 1222. The voltage divider VD includes resistive components VDa and VDb. The detector circuit DETa includes in a series path R0c, C0c and C1c. The controller circuit 1232 includes series paths CTR4 and CTR5 to generate control gate voltages for the pMOSFET 1221 and nMOSFET 1222, respectively. The series path CTR5 generates Vgatep at a node 1753 for control gate of pMOSFET 1221 and the series path CTR4 generates Vgaten at a node 1716 for the control gate of nMOSFET 1222.

The series path CTR4 includes pMOSFETs 1720 and 1721 and an nMOSFET 1722. The series path CTR5 includes a pMOSFET 1750 and nMOSFETs 1751 and 1752.

An inverter is formed by the transistors 1750 and 1751, which are connected in series with their control gates connected to one another. An inverter is also formed by the transistors 1721 and 1722, which are connected in series with their control gates connected to one another.

The detector circuit uses R0c, C0c, and C1c to form a low pass filter that detects ESD events.

The controller circuit controls the gate voltages of the BigMOS devices 1221 and 1222 using transistors 1720-1722 and 1750-1752.

During an ESD event, the circuit 1700 operates as follows. The detector circuit DETa identifies the ESD event, preventing capacitors C0b and C1b from charging immediately and keeping node 1713 (Vrc_up) and 1714 (Vrc_down) near 0 V. The pMOSFETs 1720 and 1721 are turned on while the nMOSFET 1722 is off. Node 1714 is an output of the VD. Vpmos_mid at node 1715 is elevated to the supply voltage, Vdd_esd, thus elevating Vgaten at node 1716 and turning on the nMOSFETs 1222 and 1752. Vnmos_mid at a node 1754 is set to 0 V.

The elevated Vpmos_mid turns on the nMOSFET 1751. Node 1753 is coupled to the ground rail 802 so that Vgatep=0 V. This results in a negative gate-to-source voltage to turn on the pMOSFET 1221.

During normal functionality, with no ESD event, the circuit 1500 operates as follows. The voltage divider VD sets Vrc_down to Vdd/2, for instance, and Vrc_up to Vdd, keeping the pMOSFETs 1720 and 1721 off, and the nMOSFET 1722 on. Vgaten is then at 0 V, keeping the nMOSFETs 1222 and 1752 off.

Vpmos_mid is low so that the pMOSFET 1750 is on but the nMOSFET 1751 is off. Vgatep is high so that the pMOSFET 1221 is off.

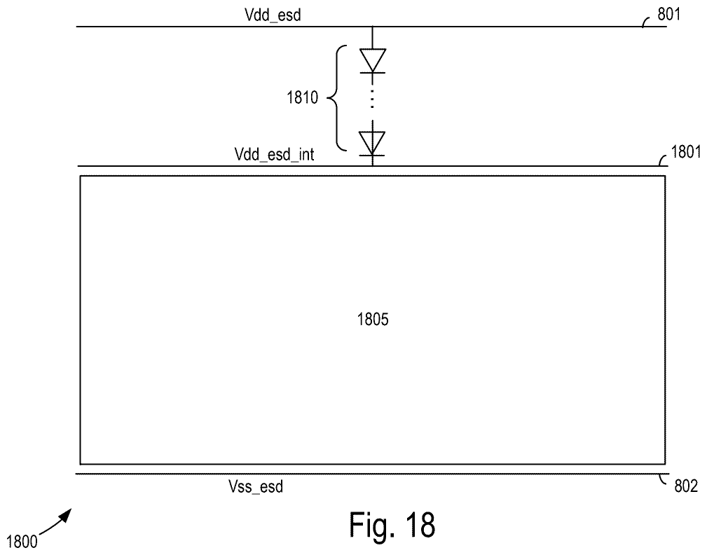

FIG. 18 depicts an ESD protection circuit 1800 which includes a series of diodes 1810 to reduce a voltage across the components of the circuit, in accordance with various embodiments. The power supply rail 801 receives Vdd_esd as before. The series of diodes is between the main power supply rail 801 and an intermediate power supply rail 1801 to reduce a voltage Vdd_esd_int at the intermediate power supply rail. The components in the region 1805 of the circuit are then subject to a reduced load. The region 1805 can represent any of the ESD circuits of FIGS. 10-17, for example.

This implementation allows for an increased supply voltage to the ESD clamp by incorporating a series of diodes between an intermediate power supply rail 1801 and the main power supply rail 801, where the voltage Vdd_esd at the main power supply rail is higher than the voltage Vdd_esd_int at the intermediate power rail.

This configuration, however, results in a trade-off of a higher clamping voltage during ESD events.

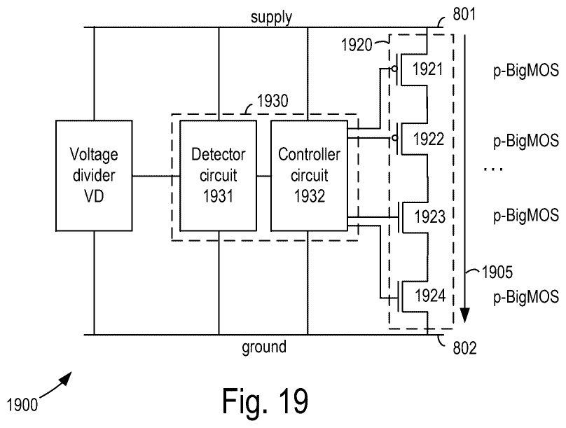

FIG. 19 depicts an ESD protection circuit 1900 similar to the circuit 1200 of FIG. 12 but with a CFET device 1950 having four stacked transistors, consistent with FIG. 3, in accordance with various embodiments. The circuit includes the voltage divider VD, a trigger circuit 1930 comprising a detector circuit 1931 and a controller circuit 1932, and a CFET device 1920 in the discharge path including pMOSFETs 1921 and 1922 and nMOSFETs 1923 and 1924. The transistors are respective BigMOSes denoted by p-BigMOS and n-BigMOS. As before, the detector circuit receives a voltage from the voltage divider and detects when an ESD event occurs, and the controller circuit is responsive to the detector circuit to control the transistors in the discharge path.

This implementation allows for the ESD clamp to handle higher voltage levels such as up to 3 V, where the cascoded ESD clamp leverages the benefits of CFET or other vertically-stacked transistor technology.

In sum, the ESD protection circuits provided herein provide a number of features. For example, the features include an area-efficient ESD clamp suitable for CFET technology, and designed to handle voltages higher than the core voltage. Another feature is the ability to implement RC components within the ESD clamp using either n-type or p-type transistors such as MOSFETs. Another feature is the inclusion of a series diode string with the ESD clamp, enabling compatibility with even higher voltage applications. Another feature is the flexibility to configure the BigMOS transistors as either nMOSFET atop pMOSFET or pMOSFET atop nMOSFET. Another feature is the implementation of a low-leakage ESD clamp design to minimize power consumption during normal operations, thereby enhancing the overall energy efficiency of the electronic device.

Another feature is the capability of the ESD clamp to protect against both positive and negative ESD events, ensuring comprehensive coverage and safeguarding of sensitive electronic components. A positive ESD event refers to an unexpected high positive voltage from the power supply rail to the ground rail and a negative ESD event refers to an unexpected low negative voltage from the power supply rail to the ground rail.

The solutions provide an ESD clamp design for IO voltage applications that is not only compatible with the compact geometries of CFET technology but also overcomes the area and reliability constraints imposed by the use of core devices in 2D ESD clamp designs. The solutions provide an area-efficient and reliable ESD protection mechanism. The solution mitigate the area penalty and interconnection weaknesses associated with the 2D stacking of core devices in traditional ESD clamp designs, thereby enabling the realization of compact, robust ESD protection mechanisms suitable for advanced semiconductor technologies.

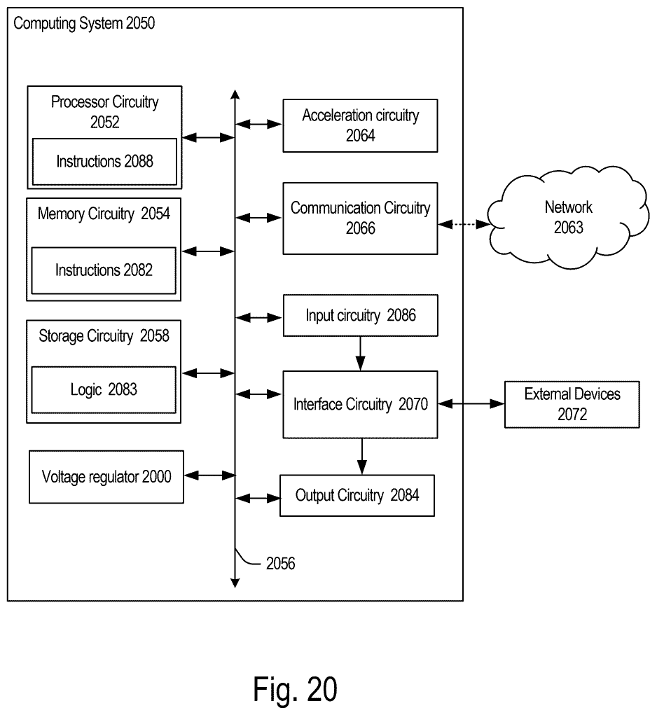

FIG. 20 illustrates an example of components that may be present in a computing system 2050 for implementing the techniques (e.g., operations, processes, methods, and methodologies) described herein.

The computing system 2050 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 2050, or as components otherwise incorporated within a chassis of a larger system. In an example implementation, the ESD protection circuit described herein is provided in one or more of the processor circuitry 2052, the memory circuitry 2054, the storage circuitry 2059, the acceleration circuitry 2064, the communication circuitry 2066, the input circuitry 2086, the interface circuitry 2070, or the output circuitry 2084.

In one approach, all or part of the computing system 2050 is provided in a SoP, System in Package (SiP) or a System on Chip (SoC).

The voltage regulator can provide a voltage Vout to one or more of the components of the computing system 2050. The memory circuitry 2054 may store instructions and the processor circuitry 2052 may execute the instructions to perform the functions described herein.

The system 2050 includes processor circuitry in the form of one or more processors 2052. The processor circuitry 2052 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 2052 may include one or more hardware accelerators (e.g., same or similar to acceleration circuitry 2064), which may be microprocessors, programmable processing devices (e.g., FPGA, ASIC, etc.), or the like. The one or more accelerators may include, for example, computer vision and/or deep learning accelerators. In some implementations, the processor circuitry 2052 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 2052 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 2052 may be coupled with or may include memory/storage and may be configured to execute instructions stored in the memory/storage to enable various applications or operating systems to run on the platform 2050. The processors (or cores) 2052 is configured to operate application software to provide a specific service to a user of the platform 2050. In some embodiments, the processor(s) 2052 may be a special-purpose processor(s)/controller(s) configured (or configurable) to operate according to the various embodiments herein.

As examples, the processor(s) 2052 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 2052 may be a part of a system on a chip (SoC), System-in-Package (SiP), a multi-chip package (MCP), and/or the like, in which the processor(s) 2052 and other components are formed into a single integrated circuit, or a single package, such as the Edison™ or Galileo™ SoC boards from Intel® Corporation. Other examples of the processor(s) 2052 are mentioned elsewhere in the present disclosure.

The system 2050 may include or be coupled to acceleration circuitry 2064, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 2064 may comprise logic blocks or logic fabric and other interconnected resources that may be programmed (configured) to perform various functions, such as the procedures, methods, functions, etc. of the various embodiments discussed herein. In such implementations, the acceleration circuitry 2064 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 2052 and/or acceleration circuitry 2064 may include hardware elements specifically tailored for machine learning and/or artificial intelligence (AI) functionality. In these implementations, the processor circuitry 2052 and/or acceleration circuitry 2064 may be, or may include, an AI engine chip that can run many different kinds of AI instruction sets once loaded with the appropriate weightings and training code. Additionally or alternatively, the processor circuitry 2052 and/or acceleration circuitry 2064 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 2052 and/or acceleration circuitry 2064 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin provided by Huawei®, and/or the like. In some hardware-based implementations, individual subsystems of system 2050 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 2050 also includes system memory 2054. Any number of memory devices may be used to provide for a given amount of system memory. As examples, the memory 2054 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 2054 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 2054 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 2058 provides persistent storage of information such as data, applications, operating systems and so forth. In an example, the storage 2058 may be implemented via a solid-state disk drive (SSDD) and/or high-speed electrically erasable memory (commonly referred to as “flash memory”). Other devices that may be used for the storage 2058 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 2054 and/or storage circuitry 2058 may also incorporate three-dimensional (3D) cross-point (XPOINT) memories from Intel® and Micron®.

The memory circuitry 2054 and/or storage circuitry 2058 is/are configured to store computational logic 2083 in the form of software, firmware, microcode, or hardware-level instructions to implement the techniques described herein. The computational logic 2083 may be employed to store working copies and/or permanent copies of programming instructions, or data to create the programming instructions, for the operation of various components of system 2050 (e.g., drivers, libraries, application programming interfaces (APIs), etc.), an operating system of system 2050, one or more applications, and/or for carrying out the embodiments discussed herein. The computational logic 2083 may be stored or loaded into memory circuitry 2054 as instructions 2082, or data to create the instructions 2082, which are then accessed for execution by the processor circuitry 2052 to carry out the functions described herein. The processor circuitry 2052 and/or the acceleration circuitry 2064 accesses the memory circuitry 2054 and/or the storage circuitry 2058 over the interconnect (IX) 2056. The instructions 2082 direct the processor circuitry 2052 to perform a specific sequence or flow of actions, for example, as described with respect to flowchart(s) and block diagram(s) of operations and functionality depicted previously. The various elements may be implemented by assembler instructions supported by processor circuitry 2052 or high-level languages that may be compiled into instructions 2088, or data to create the instructions 2088, to be executed by the processor circuitry 2052. The permanent copy of the programming instructions may be placed into persistent storage devices of storage circuitry 2058 in the factory or in the field through, for example, a distribution medium (not shown), through a communication interface (e.g., from a distribution server (not shown)), over-the-air (OTA), or any combination thereof.

The IX 2056 couples the processor 2052 to communication circuitry 2066 for communications with other devices, such as a remote server (not shown) and the like. The communication circuitry 2066 is a hardware element, or collection of hardware elements, used to communicate over one or more networks 2063 and/or with other devices. In one example, communication circuitry 2066 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 2066 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 2056 also couples the processor 2052 to interface circuitry 2070 that is used to connect system 2050 with one or more external devices 2072. The external devices 2072 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 2050, which are referred to as input circuitry 2086 and output circuitry 2084. The input circuitry 2086 and output circuitry 2084 include one or more user interfaces designed to enable user interaction with the platform 2050 and/or peripheral component interfaces designed to enable peripheral component interaction with the platform 2050. Input circuitry 2086 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 2084 may be included to show information or otherwise convey information, such as sensor readings, actuator position(s), or other like information. Data and/or graphics may be displayed on one or more user interface components of the output circuitry 2084. Output circuitry 2084 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 2050. The output circuitry 2084 may also include speakers and/or other audio emitting devices, printer(s), and/or the like. Additionally or alternatively, sensor(s) may be used as the input circuitry 2084 (e.g., an image capture device, motion capture device, or the like) and one or more actuators may be used as the output device circuitry 2084 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 2050 may communicate over the IX 2056. The IX 2056 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 2056 may be a proprietary bus, for example, used in a SoC based system.

The number, capability, and/or capacity of the elements of system 2050 may vary, depending on whether computing system 2050 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 2050 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a power supply rail; a ground rail; one or more circuits coupled to the power supply rail and the ground rail; and a discharge path coupled to the power supply rail and the ground rail, and to the one or more circuits, wherein the discharge path comprises a p-type transistor and an n-type transistor stacked one atop the other.

Example 2 includes the apparatus of Example 1, wherein the one or more circuits comprise: a voltage divider coupled to the power supply rail and the ground rail; a low pass filter coupled to the power supply rail, the ground rail, and an output of the voltage divider; and a controller circuit coupled to the power supply rail, the ground rail, the low pass filter, the p-type transistor and the n-type transistor.

Example 3 includes the apparatus of Example 2, wherein the controller circuit is configured to, based on the low pass filter, turn on the p-type and n-type transistors during an electrostatic discharge (ESD) event.

Example 4 includes the apparatus of any one of Examples 1-3, wherein the one or more circuits comprise: a first series path coupled to the power supply rail and the ground rail; and a second series path coupled to the power supply rail and the ground rail, wherein: the first series path comprises a node coupled to a control gate of the n-type transistor; and the second series path comprises a node coupled to a control gate of the p-type transistor.

Example 5 includes the apparatus of any one of Examples 1-4, further comprising: an intermediate voltage rail between the power supply rail and the ground rail; and one or more diodes coupled to the intermediate voltage rail and the power supply rail.

Example 6 includes the apparatus of any one of Examples 1-5, wherein the p-type transistor and the n-type transistor are stacked one atop the other in a complementary field-effect transistor (CFET) device.

Example 7 includes the apparatus of Example 6, wherein: the CFET device is arranged in parallel in a set of CFET devices in the discharge path; and respective CFET devices in the set of CFET devices comprise a p-type transistor and an n-type transistor stacked one atop the other.

Example 8 includes the apparatus of Example 7, wherein adjacent CFET devices of the set of CFET devices have respective source/drain regions in shared silicon regions.

Example 9 includes the apparatus of any one of Examples 6-8, wherein the p-type transistor and the n-type transistor are among four transistors stacked one atop the other in the CFET device in the discharge path.

Example 10 includes the apparatus of any one of Examples 1-9, wherein the apparatus is provided in at least one of an integrated circuit, a System on Chip, a System in Package or a computing device.

Example 11 includes an apparatus, comprising: a power supply rail; a ground rail; a discharge path coupled to the power supply rail and the ground rail, wherein the discharge path comprises a p-type transistor and an n-type transistor stacked one atop the other; a first series path coupled to the power supply rail and the ground rail, wherein the first series path comprises a first p-type transistor having a source coupled to the power supply rail and a second p-type transistor having a drain coupled to the ground rail and to a control gate of the n-type transistor in the discharge path; and a second series path coupled to the power supply rail and the ground rail, wherein the second series path comprises a p-type transistor having a source coupled to the power supply rail and a drain coupled to a control gate of the p-type transistor in the discharge path.

Example 12 includes the apparatus of Example 11, wherein the first p-type transistor has a drain coupled to a source of the second p-type transistor.

Example 13 includes the apparatus of Example 11 or 12, wherein the drain of the second p-type transistor in the first series path is coupled to the ground rail via a resistor.

Example 14 includes the apparatus of any one of Examples 11-13, wherein, in the first series path: the drain of the second p-type transistor is coupled to the ground rail via an n-type transistor; and the n-type transistor and the second p-type transistor are connected as an inverter.

Example 15 includes the apparatus of any one of Examples 11-14, wherein, in the second series path: the drain of the p-type transistor is coupled to the ground rail via an n-type transistor; and the n-type transistor and the p-type transistor are connected as an inverter.

Example 16 includes the apparatus of any one of Examples 11-15, further comprising: a voltage divider coupled to the power supply rail and the ground rail; a third series path coupled to the power supply rail and the ground rail, wherein the third series path comprises a resistor coupled to the power supply rail, and a capacitor coupled between the power supply rail and an output node of the voltage divider, and a control gate of the first p-type transistor is coupled to a node between the resistor and the capacitor.

Example 17 includes the apparatus of Example 16, further comprising, in the third series path, a capacitor coupled between the output node of the voltage divider and the ground rail, wherein a control gate of the second p-type transistor is coupled to the output node of the voltage divider.

Example 18 includes a system, comprising: a power supply rail; a ground rail; a victim circuit coupled to the power supply rail and the ground rail; and an electrostatic discharge (ESD) protection circuit coupled to the power supply rail and the ground rail, wherein the ESD protection circuit comprises a discharge path from the power supply rail to the ground rail via one or more complementary field-effect transistor (CFET) devices.

Example 19 includes the system of Example 18, wherein the discharge path comprises a set of CFET devices in parallel.

Example 20 includes the system of Example 18 or 19, wherein the discharge path comprises multiple vertically-stacked transistors in respective CFET devices of the one or more CFET device.

Example 21 includes a method, comprising: receiving a voltage of an electrostatic discharge an event at a power supply rail; and discharging the voltage to a ground rail via a discharge path, wherein the discharge path comprises a p-type transistor and an n-type transistor stacked one atop the other.

Example 22 includes the method of Example 21, wherein the p-type transistor and the n-type transistor are stacked one atop the other in a complementary field-effect transistor (CFET) device.

Example 23 includes an apparatus, comprising means to perform the method of Example 21 or 22.

Example 24 includes a machine-readable storage including machine-readable instructions which, when executed, cause a computer to implement the method of Example 21 or 22.

Example 25 includes a computer program comprising instructions which, when executed by a computer, cause the computer to carry out the method of Example 21 or 22.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a power supply rail;
a ground rail;
one or more circuits coupled to the power supply rail and the ground rail; and
a discharge path coupled to the power supply rail and the ground rail, and to the one or more circuits, wherein the discharge path comprises a p-type transistor and an n-type transistor stacked one atop the other.

2. The apparatus of claim 1, wherein the one or more circuits comprise:
a voltage divider coupled to the power supply rail and the ground rail;
a low pass filter coupled to the power supply rail, the ground rail, and an output of the voltage divider; and
a controller circuit coupled to the power supply rail, the ground rail, the low pass filter, the p-type transistor and the n-type transistor.

3. The apparatus of claim 2, wherein the controller circuit is configured to, based on the low pass filter, turn on the p-type and n-type transistors during an electrostatic discharge (ESD) event.

4. The apparatus of claim 1, wherein the one or more circuits comprise:
a first series path coupled to the power supply rail and the ground rail; and
a second series path coupled to the power supply rail and the ground rail, wherein:
the first series path comprises a node coupled to a control gate of the n-type transistor; and
the second series path comprises a node coupled to a control gate of the p-type transistor.

5. The apparatus of claim 1, further comprising:
an intermediate voltage rail between the power supply rail and the ground rail; and
one or more diodes coupled to the intermediate voltage rail and the power supply rail.

6. The apparatus of claim 1, wherein the p-type transistor and the n-type transistor are stacked one atop the other in a complementary field-effect transistor (CFET) device.

7. The apparatus of claim 6, wherein:
the CFET device is arranged in parallel in a set of CFET devices in the discharge path; and
respective CFET devices in the set of CFET devices comprise a p-type transistor and an n-type transistor stacked one atop the other.

8. The apparatus of claim 7, wherein adjacent CFET devices of the set of CFET devices have respective source/drain regions in shared silicon regions.

9. The apparatus of claim 6, wherein the p-type transistor and the n-type transistor are among four transistors stacked one atop the other in the CFET device in the discharge path.

10. The apparatus of claim 1, wherein the apparatus is provided in at least one of an integrated circuit, a System on Chip, a System in Package or a computing device.

11. An apparatus, comprising:
a power supply rail;
a ground rail;
a discharge path coupled to the power supply rail and the ground rail, wherein the discharge path comprises a p-type transistor and an n-type transistor stacked one atop the other;
a first series path coupled to the power supply rail and the ground rail, wherein the first series path comprises a first p-type transistor having a source coupled to the power supply rail and a second p-type transistor having a drain coupled to the ground rail and to a control gate of the n-type transistor in the discharge path; and
a second series path coupled to the power supply rail and the ground rail, wherein the second series path comprises a p-type transistor having a source coupled to the power supply rail and a drain coupled to a control gate of the p-type transistor in the discharge path.

12. The apparatus of claim 11, wherein the first p-type transistor has a drain coupled to a source of the second p-type transistor.

13. The apparatus of claim 11, wherein the drain of the second p-type transistor in the first series path is coupled to the ground rail via a resistor.

14. The apparatus of claim 11, wherein, in the first series path:
the drain of the second p-type transistor is coupled to the ground rail via an n-type transistor; and
the n-type transistor and the second p-type transistor are connected as an inverter.

15. The apparatus of claim 11, wherein, in the second series path:
the drain of the p-type transistor is coupled to the ground rail via an n-type transistor; and
the n-type transistor and the p-type transistor are connected as an inverter.

16. The apparatus of claim 11, further comprising:
a voltage divider coupled to the power supply rail and the ground rail;
a third series path coupled to the power supply rail and the ground rail, wherein the third series path comprises a resistor coupled to the power supply rail, and a capacitor coupled between the power supply rail and an output node of the voltage divider, and a control gate of the first p-type transistor is coupled to a node between the resistor and the capacitor.

17. The apparatus of claim 16, further comprising, in the third series path, a capacitor coupled between the output node of the voltage divider and the ground rail, wherein a control gate of the second p-type transistor is coupled to the output node of the voltage divider.

18. A system, comprising:
a power supply rail;
a ground rail;
a victim circuit coupled to the power supply rail and the ground rail; and
an electrostatic discharge (ESD) protection circuit coupled to the power supply rail and the ground rail, wherein the ESD protection circuit comprises a discharge path from the power supply rail to the ground rail via one or more complementary field-effect transistor (CFET) devices.

19. The system of claim 18, wherein the discharge path comprises a set of CFET devices in parallel.

20. The system of claim 18, wherein the discharge path comprises multiple vertically-stacked transistors in respective CFET devices of the one or more CFET device.
